(19) United States
(12) Patent Application Publication
(10) Pub. No.: US 2017/0295811 A1
(43) Pub. Date: Oct. 19, 2017

(54) CHEESE COMPOSITION AND PROCESS FOR MAKING IT

(71) Applicant: NESTEC S.A., Vevey (CH)

(72) Inventors: Paul Stober, Beauvai (FR); Christian Guiot, Le Breuil-en-Auge (FR); Claude Parmantier, Glos (FR)

(21) Appl. No.: 15/516,263

(22) PCT Filed: Sep. 30, 2015
(86) PCT No.: PCT/EP2015/072555

§ 371 Date: Mar. 31, 2017

(30) Foreign Application Priority Data
Oct. 3, 2014 (EP) 14187675.5

(51) Int. Cl. A23C 19/09

(52) U.S. Cl. CPC A23C 19/09; A23C 19/0917

(57) ABSTRACT

The present invention relates to a process for making a cheese composition that produces a high viscosity fluid cheese product for industrial application. A further aspect of the present invention is the cheese composition obtainable by the process and food products comprising said cheese composition.

The present invention relates to processing of cheese and in particular to a process for making a cheese composition that produces a high viscosity fluid cheese product for industrial application. A further aspect of the present invention is the cheese composition obtainable by the process and food products comprising said cheese composition.

Cheese and processed cheese products are used industrially in the preparation of a large variety of different food products. Particularly, cheese is used in many of those food products as a topping to improve taste, indulgence and the appearance of the food product. Some prominent examples are pizza products as well as pasta with cheese products such as macaroni and cheese. Thereby, traditionally, blocks of cheese are shredded to small cheese snips or cut into pieces and those snips or pieces are then used to top the respective food products.

Alternatively, processed cheese has already been formed into smaller pieces or slices which can be used for example directly for topping such food products. The methods of processing cheese usually include the incorporation of artificial additives into the cheese mass. However, modern consumers shuns from food products and food ingredients having additives from unnatural origin. Modern health-conscious consumers demand today a higher level of food product quality than ever, and seek to consume foods that are free from artificial, non-natural additives.

Furthermore, the use of solid cheese pieces or snips are not very easy to handle in an industrial factory setting as they produce a lot of waste, are difficult to transport and portion, and generally produce quite some mess around the cheese handling installations. The efficiency of modern high throughput processing and packaging machinery is therefore facilitated by using cheese products that are substantially fluid and can be pumped, poured and portioned as a fluid or paste directly onto the appropriate food products.

For example, WO 2008/122094 A1 discloses processes for liquefying cheese to produce a low viscosity product with enhanced such handling properties. Particularly, the document discloses that hard cheeses, such as cheddar cheese, and some soft cheeses, such as cottage and cream cheese, can be liquefied with water if run through specific heating step processes. No artificial substances have to be added to the cheese product. However, there is still an opportunity for improvement of the liquefied cheese product as to texture properties and particularly also to organoleptic properties such as taste and flavour.

Therefore, the object of the present invention is to improve the state of the art and to provide an improved or at least alternative solution to overcome at least some of the inconveniences described above. Particularly, the object of the present invention is to provide a new process for making a cheese composition which is natural, i.e. with no artificial ingredients, which is substantially fluid and can be pumped, poured and portioned onto food products and which has improved texture properties and/or organoleptic properties as to taste and flavour over the known solutions of the prior art.

The object of the present invention is achieved by the subject matter of the independent claims. The dependent claims further develop the idea of the present invention.

Accordingly, the present invention provides in a first aspect a process for making a cheese composition comprising the steps of:

a) blending 25-75 wt % cheese with 25-75 wt % liquid milk to obtain a cheese-milk blend;

b) pasteurizing the cheese-milk blend at a temperature of 72° C. or above; p c) optionally homogenizing the pasteurized cheese-milk blend;

d) acidifying the pasteurized cheese-milk blend to a pH from 4.0 to 6.5;

e) cooling the acidified cheese-milk blend to a temperature of 8° C. or below.

A second aspect relates to a cheese composition obtainable by the process of the present invention. And a still further aspect relates to a food product comprising this cheese composition.

While experiencing with making liquefied cheese products, the inventors have found that when liquefying cheese with milk, instead as with water, and then after a pasteurization step adjusting the pH of the cheese-milk composition to acid condition of pH 4.0 to about 6.5, a remarkable improvement of the liquefied cheese product can be obtained. Particularly, the inventors observed that the resulting liquefied cheese composition has improved texture properties, i.e. the composition is not too thick to be still well capable of being pumped in an industrial setting, and it is not too thin as it well stays embossed on a food product, e.g. as a topping on a pizza, after its dosing application. Furthermore, the organoleptic property of the resulting cheese composition is improved and the natural taste and aroma of the original cheese product is better preserved. Still further, as the cheese composition has been pasteurized, it is microbiologically safe as undesired bacteria and molds have been inactivated.

Still further, the inventors have found that when acidifying the liquefied cheese-milk composition after pasteurization by lactic fermentation, the texture property of the resulting cheese composition can be controlled even better and adapted to any specific application needs by varying the fermentation conditions and/or the selection of the lactic acid bacteria used for the fermentation. Even more so, acidification by lactic fermentation allows modulating and further improving the taste and aroma of the resulting cheese composition. Particularly, it is now possible to quasi mimic the complete sensory properties of the original cheese with the resulting cheese composition.

Consequently, the advantage of the new process is that the resulting liquefied cheese product is smoother and firmer in texture, allowing an improved industrial application, as well as having significantly improved organoleptic properties. This allows for example: to reduce costs as less original cheese material is required for a same quantity of cheese topping for a food product; to modulate and/or change the sensory cheese experience by combining different cheeses with different lactic fermentations; to provide a liquefied cheese product which does not contain artificial ingredients such as non-milk based emulsifiers, stabilizers and/or thickeners; and even to change the nutritional profile of the cheese product as lower salt and lower saturated fat products can be generated with this new process.

### DETAILED DESCRIPTION OF THE INVENTION

The present invention pertains to a process for making a cheese composition comprising the steps of:

a) blending 25-75 wt % cheese with 25-75 wt % liquid milk to obtain a cheese-milk blend;

b) pasteurizing the cheese-milk blend at a temperature of 72° C. or above;

c) optionally homogenizing the pasteurized cheese-milk blend;

d) acidifying the pasteurized cheese-milk blend to a pH from 4.0 to 6.5;

e) cooling the acidified cheese-milk blend to a temperature of 8° C. or below.

Preferably, step a) is blending 40-65 wt % cheese with 35-60 wt % liquid milk to obtain the cheese-milk blend.

“Blending” refers to a process of mixing to achieve an apparent homogenous mixture.

“Liquid milk” of the present invention refers to fresh milks comprising no fat, low fat and full fat milks.

In a preferred embodiment, the process of the present invention further comprises in step a) adding milk protein concentrate, milk fat concentrate and/or a vegetable fat to the cheese-milk blend. This advantageously allows standardizing the liquid milk composition as to protein and/or fat content, important in an industrial setting. The vegetable fat comprises oils and fats extracted from plant materials such as for example palm oil, colza or rapeseed oil, soybean oil, sunflower oil, cottonseed oil, olive oil, coconut oil, corn oil, safflower oil, or combinations thereof.

Acidification in step d) can be achieved e.g. by adding an organic acid as for example lactic acid, an acid fermented milk serum, and/or by direct fermentation. Preferably, the pasteurized cheese-milk blend in step d) of the present process is acidified to a pH from 4.0 to 5.8, more preferably to a pH from 4.3 to 5.5, even more preferably to a pH from 4.5 to 5.2. A preferred pH value is advantageously chosen according to the selected cheese or cheeses used in the blending step and the desired final sensory profile of the resulting cheese composition.

In one embodiment, acidification of step d) is carried out in the process of the present invention after termination of the pasteurization step b).

In a preferred embodiment, the pasteurized cheese-milk blend in step d) of the present invention is acidified by lactic fermentation. Preferably, the lactic fermentation is initiated by an addition of mesophilic and/or thermophilic lactic acid bacteria. Preferably, the lactic acid bacteria are selected from the group consisting of lactobacilli, lactococci and streptococci. Typically, the lactic fermentation is carried out at a temperature from 25° C. to 45° C. for at least 2 hours, preferably for at least 4 hours. Preferably, the lactic fermentation does not exceed a time period of 36 hours, preferably not exceeding 24 hours.

In a preferred embodiment, rennet is added to the pasteurized cheese-milk blend in step d) of the present process. The inventors observed that the addition of rennet has the advantage of improving the textural property and consistency of the final cheese composition. Particularly, the viscosity of the cheese composition was positively increased and a ‘smoothing’ of the composition e.g. via homogenization as of step c) of the present process was much less required.

In preferred embodiments, the cheese for making the cheese composition as of the present process is selected from the group consisting of goat cheese, blue cheese, fresh cheese, Camembert cheese, Brie cheese, cottage cheese, cream cheese, feta cheese, ricotta cheese, mozzarella cheese, Emmental, Gruyère and Comté, or a combination thereof. The blue cheese includes preferably Gorgonzola, Roquefort and le bleu d'Auvergne. A most preferred embodiment is where the cheese is a goat cheese or a Gorgonzola cheese.

A further embodiment of the present invention pertains to a process for making a cheese composition, wherein the cheese is a combination of at least two different cheeses selected from the group of cheeses mentioned above. Preferably, one of those at least two different cheeses is a goat cheese. Combining two or more different cheeses into one single cheese composition has the advantage that it allows to create completely new cheese flavor profiles and taste experiences for consumers. It allows to balance out e.g. a pronounced single strong cheese flavor in the composition and/or to combine different flavors into one concerted single taste experience.

Preferably, the process of the present invention does not comprise a step of adding an emulsifier, stabilizer and/or thickener. Preferably, the process of the present invention does not comprise a step of adding a non-milk based emulsifier, stabilizer and/or thickener, wherein for example such emulsifier, stabilizer and/or thickener is selected from the group consisting of melting salts, xanthan gum, gum Arabic, guar gum, locust bean gum, cellulose, alginate, pectin, agar, carrageenan, starch, lecithin, mono- and diglycerides of fatty acids, esters of fatty acids, sorbitol, glycerol, polysorbate, konjac, cassia gum and gelatin, or a combination thereof. Modern consumers do not like to have food ingredients with a lot of artificial, non-natural additives.

Hence, advantageously, the present embodiment relates to an all-natural cheese composition which is presently much preferred by modern consumers, conscious of health and wishing to reduce artificial additives.

In a preferred embodiment, the process of the present invention further comprises a step of adding herbs and/or spices. This relates to an incorporation of herbs and/or spices directly into the cheese composition before its application e.g. onto a food product. Advantageously then herbs and/or spices do not need to be applied separately onto such a food product, which would result in an additional production step, increasing complexity and costs of production. Furthermore, dosing of such herbs and/or spices would be much easier and more consistent for an industrial application. And still further, as the herbs and/or spices would not need to be applied anymore individually e.g. on a production line, the dust level generated by such an application would be drastically reduced.

A further aspect of the present invention relates to a cheese composition obtainable by the present process. And a still further aspect relates to a food product comprising this cheese composition. Preferably, such a food product of the present invention is a pizza product, a sandwich product or a prepared dish, preferably a prepared pasta dish.

Those skilled in the art will understand that they can freely combine all features of the present invention disclosed herein. In particular, features described for the process of the present invention may be combined with the products of the present invention, and vice versa. Further, features described for different embodiments of the present invention may be combined.

Further advantages and features of the present invention are apparent from the examples.

### Example 1

62 wt % goat cheese was added together with 32.6 wt % liquid skimmed milk, 4 wt % milk cream (35% fat content) and 1.4 wt % milk protein powder into a tank and thoroughly mixed for 3 hours at 8° C. Thereafter, the mixture was pasteurized at 95° C. for 15 minutes, and cooled thereafter to 27° C. The cheese-milk mixture was then inoculated with 0.001 wt % of a commercial mesophilic lactic acid bacteria starter culture and incubated for 14 hours at 27° C. to reach a pH value of 4.50. Thereafter the fermented mixture was cooled down to 4° C., where it was stored for several days.

The fermented cheese composition was now ready for being applied as a liquid cheese topping onto ready-made pizza products. Such pizza products could now be baked directly before consumption, or alternatively be frozen at −15° C. for storage and further distribution.

### Example 2

51 wt % goat cheese was added together with 46.5 wt % liquid whole milk, and 2.5 wt % milk protein powder into a tank and thoroughly mixed for 3 hours at 8° C. Thereafter, the mixture was pasteurized at 92° C. for 2 minutes, and cooled thereafter to 27° C.

The cheese-milk mixture was then inoculated with 0.001 wt % of a commercial mesophilic lactic acid bacteria starter culture, mixed and portioned into plastic containers. They were then incubated for 14 hours at 27° C. until pH 4.50 of the mixture was reached. Thereafter the containers were cooled down to 4° C., where they were stored for several days until use.

The fermented cheese composition was now ready for being applied as a liquid cheese topping onto ready-made pizza products. Such pizza products could now be baked directly before consumption, or alternatively be frozen at −15° C. for storage and further distribution.

### Example 3

A same cheese composition recipe was produced twice in parallel with two different processes, once with a batch process with using a Stephan cooking mixer, and once with a continuous process as commonly used in the dairy industry and with using an YtronZ high shear fluid mixer for homogenization.

The final recipe of the composition was as follows: 62 wt % goat cheese, 36.899 wt % liquid full fat milk, 1 wt % milk protein powder, 0.001 rennet (casein 90 mesh), and 0.1 wt % a commercial mesophilic lactic starter strain.

### Batch Process

The goat cheese, liquid milk and milk powder were added together into a Stephan mixer and mixed for 5 hours at 8° C. with a mixing speed of 25%. Thereafter, the mixture was heated to 92° C. where it was kept for 2 min under the same mixing conditions. Thereafter, the mixture was cooled to 28° C. The rennet and the lactic starter strain where then added and the mixture was kept at 28° C. for 15 hours. Thereafter, the composition was filled into containers, cooled and stored at 4° C.

The final composition had a pH of 4.57 and a Brookfield viscosity of 38′200 cP 3 hours after the cooling step and a Brookfield viscosity of 60′600 cP 24 hours after the cooling step.

### Continuous Process

The goat cheese, liquid milk and milk powder were added together into a tank and mixed for 12 hours at 8° C. Thereafter, the mixture was pasteurized on a plate heat exchanger at 92° C. for 3 minutes. The mixture was then homogenized with an YtronZ fluid mixer and cooled thereafter to 28° C. The rennet and the lactic starter strain were then admixed and the composition portion packed into pouches. Those pouches were then kept at 28° C. for 15 hours for fermentation of the content, and thereafter cooled and stored at 4° C.

The final composition had a pH of 4.56 and a Brookfield viscosity of 22′500 cP 3 hours after the cooling step and a

Brookfield viscosity of 27′700 cP 24 hours after the cooling step.

The fermented cheese composition was now ready for being applied as a liquid cheese topping onto ready-made pizza products. Such pizza products could now be baked directly before consumption, or alternatively be frozen at −15° C. for storage and further distribution.

1. A process for making a cheese composition comprising the steps of:
a) blending 25-75 wt % cheese with 25-75 wt % liquid milk to obtain a cheese-milk blend;
b) pasteurizing the cheese-milk blend at a temperature of 72° C. or above;
c) acidifying the pasteurized cheese-milk blend to a pH from 4.0 to 6.5; and
d) cooling the acidified cheese-milk blend to a temperature of 8° C. or below.

2. The process according to claim 1, wherein step a) blending 40-65 wt % cheese with 35-60 wt % liquid milk to obtain the cheese-milk blend.

3. The process according to claim 1, wherein step a) comprises adding a component selected from the group consisting of milk protein concentrate, milk fat concentrate and vegetable fat to the cheese-milk blend.

4. The process according to claim 1, wherein the pasteurized cheese-milk blend in step c) is acidified to a pH from 4.0 to 5.8.

5. The process according to claim 1, wherein the pasteurized cheese-milk blend in step c) is acidified by lactic fermentation.

6. The process according to claim 5, wherein lactic fermentation is initiated by an addition of mesophilic and/or thermophilic lactic acid bacteria.

7. The process according to claim 6, wherein the lactic fermentation is carried out at a temperature from 25° C. to 45° C. for at least 2 hours.

8. The process according to claim 1, wherein rennet is added to the pasteurized cheese-milk blend in step c).

9. The process according to claim 1, wherein the cheese is selected from the group consisting of goat cheese, blue cheese, fresh cheese, Camembert cheese, Brie cheese, cottage cheese, cream cheese, feta cheese, ricotta cheese, Comté, Gouda, Gruyère, Emmental and mozzarella cheese, and combinations thereof.

10. The process according to claim 9, wherein the cheese is a combination of at least two cheeses selected from the group.

11. The process according to claim 1, which does not comprise a step of adding an emulsifier, a stabilizer and/or a thickener.

12. The process according to claim 1, comprising a step of adding herbs and/or spices.

13. A cheese composition obtainable by the process according to claim 1.

14. A food product comprising a cheese composition obtained by the process of claim 1.

15. The food product according to claim 14 which is selected from the group consisting of a pizza product, a sandwich product and a prepared dish.
